(19) United States
(12) Patent Application Publication
(10) Pub. No.: US 2024/0343131 A1
(43) Pub. Date: Oct. 17, 2024

(54) GROUND CONTACT UNIT FOR A VEHICLE BATTERY CHARGING SYSTEM

(71) Applicant: Easelink GmbH, Graz (AT)

(72) Inventors: Martin ZAVERSKY, Graz (AT); Maximilian HOFER, Graz (AT); Christian RIEDL, Graz (AT); Hermann STOCKINGER, Graz (AT)

(21) Appl. No.: 18/292,476

(22) PCT Filed: Jul. 28, 2022
(86) PCT No.: PCT/EP2022/071250

§ 371 Date: Jan. 26, 2024

(30) Foreign Application Priority Data
Jul. 28, 2021 (DE) 10 2021 119 665.5

(51) Int. Cl. B60L 53/16; B60L 53/30; H01R 12/71; H01R 13/24

(52) U.S. Cl. CPC B60L 53/16; B60L 53/30; H01R 12/714; H01R 13/2421; H01R 13/2457

(57) ABSTRACT

A ground contact unit for a vehicle battery charging system, having a ground-side base and an upper outer wall, wherein a receiving space in which at least one printed circuit board is positioned is formed between the base and the outer wall, and having a plurality of contacts provided on the outside of the outer wall for contacting vehicle-side mating contacts, the contacts being electrically conductively connected to the printed circuit board by means of electrical lines, wherein the lines are formed, at least in sections, by flexible, freely extending contact bridges which are configured to undergo a spring deflection toward the base.

### FIELD OF THE INVENTION

The invention relates to a ground contact unit for a vehicle battery charging system.

### BACKGROUND OF THE INVENTION

For electrically powered vehicles, conductive charging systems are known in which an electrical line is established in an automated manner between a vehicle-side part (also referred to as vehicle contact unit) and a part that rests stationarily on the ground (referred to as ground contact unit).

For this purpose, electrical contacts are usually provided on the underbody of the vehicle, which can be brought into contact with the corresponding contact surfaces of the ground contact unit when required.

Such a ground contact unit is disclosed, for example, in WO 2019/052962 A1. This ground contact unit has a ground-side base and an upper outer wall, between which a receiving space is formed in which the electronics is received. At least one printed circuit board is provided, which is electrically connected to contacts that are provided on the outside of the outer wall. These contacts are then approached by a vehicle-side connector in order to couple electrically when the vehicle needs to be charged. Provided on the upper outer wall are numerous of these contacts, two or three or more of which (i.e. of those contacts that touch mating contacts) then transmit the charging current when the connector has been coupled. Having a plurality of contacts distributed over the outer wall means that it is not necessary to optimally orient the vehicle with respect to the ground contact unit. Only those or some of those contacts that are in optimum contact with the mating contacts on the connector of the vehicle are eventually connected to carry current.

As already mentioned, the contacts on the outer wall are connected to the printed circuit board in a current-carrying manner, which is usually effected by means of pins provided on the contacts on the rear side thereof.

Since it may occur that the ground contact unit is also driven over, i.e. is subjected to a considerable weight load of possibly several tons, there is a need to construct these ground contact units to be robust so that they will function safely for many years, while it has to be ensured here that the electrical connections in the interior of the ground contact unit remain intact despite the mechanical load from the outside.

### SUMMARY OF THE INVENTION

This object is achieved by a ground contact unit for a vehicle battery charging system, including a ground-side base and an upper outer wall, wherein a receiving space in which at least one printed circuit board is positioned is formed between the base and the outer wall, and including a plurality of contacts provided on the outside of the outer wall for contacting vehicle-side mating contacts, the contacts being electrically conductively connected to the printed circuit board by means of electrical lines. The lines are formed, at least in sections, by flexible, freely extending contact bridges which are configured to be spring-deflectable toward the base.

The flexible, freely extending contact bridges in the line routing between the respective contact on the outer wall and the printed circuit board allow the outer wall to yield somewhat elastically itself when subjected to a load, without this having an adverse effect on the fatigue strength of the parts of the electrical lines and their fastening points. The solution contemplated so far of soldering the pins to the printed circuit board and providing a high-stability outer wall is replaced by the invention. That is, an elasticity is intentionally chosen, rather than rigidity of the system.

The printed circuit board is preferably accommodated so as to be suspended in the receiving space, and the contact bridges are mounted to one of the top side and the bottom side of the printed circuit board. In particular, the contact bridges start at the printed circuit board, because here the connection to the respective flexible contact bridges can be made relatively simply in an automated manner. Due to the positioning on the top side or the bottom side, it is mainly a tensile load that is exerted on the respective fastening point on the printed circuit board vertically away from the printed circuit board and not so much a problematic shearing load.

In a side view or a top view of the ground contact unit, the contact bridges can each describe at least one arc the shape of which changes when the associated contact moves perpendicularly to the upper outer wall, with the contact bridge being elastically deformed. This arrangement ensures that the contact bridge itself is subjected to little stress and can at the same time act as an optimum decoupling means between the adjacent parts of the electrical line. Preferably, the arc is open to the side or to the top, i.e. a reclining or an upright “U” is involved, which is formed by the contact bridge. The free ends of the legs then form the transitions to the adjacent parts, e.g. to the printed circuit board or the pin or directly to the contact on the outer wall.

A more problematic issue is to securely attach the contact bridges to the adjacent part of the electrical line. According to one variant, the invention here provides that the contact bridges are fastened by their ends to the respectively adjacent part by wire bonding or welding or soldering. Alternatively, the contact bridges may also be fastened by their ends to the respectively adjacent part by pressing, crimping, clamping or screwing. Wire bonding here involves the use of a wire, typically made of aluminum, which is fastened directly to the adjacent part by applying vibrations and heat. The wire then forms the contact bridge. This method distinguishes itself by a high long-term stability and is very cost-effective, since it can be largely automated. So-called laser bonding may also be applied.

As already indicated above, pins may be provided on the inside of the contacts on the outer wall, the pins extending toward the associated printed circuit board and constituting a section of the respective electrical line. The pins may be formed as separate parts here, i.e. they do not continue into the contacts in one piece. As an alternative, however, the pins may continue into the contacts in one piece by being integrally formed with the contacts on the rear side thereof and projecting from them. Provided between the pins and the printed circuit board is at least one respective contact bridge, which is resiliently deflectable as a spring in the longitudinal direction of the pins and electrically connects the pin to the printed circuit board. The pins preferably project perpendicularly from the rear side of the associated contact so that they are displaced vertically when the outer wall is loaded.

If the pin extends past the associated printed circuit board, i.e. extends laterally on the outer wall thereof or through a recess or opening, the contact bridge can be attached very easily to the underside of the pin, for example, and subsequently it extends in an arc, for example an upright U, to the underside of the printed circuit board. This orientation of the contact bridge has turned out to be very advantageous in terms of long-term stability.

A plurality of contact bridges may be jointly bonded or welded or soldered to at least one printed circuit board and/or associated pins in order to reduce the cycle time in a fully automated manufacture.

Also, the contact bridges can optionally be integrated into the associated printed circuit board, i.e. the printed circuit board has a kind of flexible, electrically conductive extension that forms the contact bridge and is fastened by its free end to the associated pin. As a result, no separate part is required to provide the contact bridge.

Additional safety in terms of long-term stability may be provided for by a plurality of contact bridges per pin, allowing for the possibility of a failure of a contact bridge.

To ensure the positioning of the contact bridges within the receiving space, at least some, preferably all contact bridges may be received in a mounting holder which is accommodated within the receiving space. This mounting holder positions the contact bridges relative to the at least one printed circuit board and, if pins are provided, to these pins. In particular, this mounting holder provides for optimum orientation of the contact bridge with a view to fatigue strength. For example, the U-shaped contact bridge, which has already been mentioned several times above, is oriented such that the “U” is, e.g., arranged to be exactly horizontal or upright. Also, contact bridges are prevented from coming into contact with other contact bridges in order to prevent friction between them.

The pins may be welded to the contacts of the outer wall, in particular by contact welding. Where necessary, the materials for the contacts and the pins may therefore be different, although this is not necessarily the case.

A lateral, optional guide for each pin further provides for an always constant, optimized orientation of the lines for a predetermined bend under load.

The lateral guide may comprise a holding plate having sleeves formed integrally with it or sleeves inserted in it, through which the pins extend.

The printed circuit board may, for example, be mounted by a holder so as to be spaced away from the base and may be fastened to the outer wall. This is intended to reduce the relative movement of the electrical lines when the ground contact unit is mechanically loaded. The holder may also comprise the holding plate and the sleeves, which is optional.

To this end, the holding plate may be fastened, on the one hand, to the outer wall and, on the other hand, to the at least one printed circuit board in order to hold the printed circuit board suspended.

Generally and without limitation to the above-mentioned combination of features, the printed circuit board is preferably floatingly supported in the receiving space in order to keep loads away from it as far as possible. To this end, the printed circuit board may, for example, be installed such that it is suspended, possibly with selective support from below, so that the printed circuit board is still movable laterally.

In a further variant of the invention, the holding plate and the outer wall are positioned laterally in relation to each other by projections that engage in recesses. This means that a mechanical coupling is provided.

Furthermore, support parts may be provided between the outer wall and the base, which support the outer wall on the base in the vertical direction. These support parts or, where applicable, a single singular support part is/are intended to ensure mechanical stability of the outer wall relative to the base in order to prevent the outer wall from a spring deflection too much when a vehicle drives over it.

The support parts may be integrally formed with the base and have a pin-like configuration.

An electrically conductive intermediate plate may be provided on the rear side of the outer wall in order to electrically combine a plurality of protective earth contacts on the rear side of the outer wall. These line sections are connected, on the one hand, to associated protective earth contacts and, on the other hand, to the printed circuit board by a shared contact bridge. This allows the number of contact bridges to be reduced.

### BRIEF DESCRIPTION OF THE DRAWINGS

Further features and advantages of the invention will be apparent from the drawings below and from the description below, to which reference is made.

In the drawings:

FIG. 1 shows a schematic top view of a ground contact unit according to the invention;

FIG. 2 shows a schematic sectional side view of the ground contact unit;

FIG. 3 shows a schematic sectional view of the ground contact unit according to a first embodiment of the invention;

FIG. 4 shows a schematic sectional view of the ground contact unit according to a second embodiment of the invention;

FIG. 5 shows a schematic sectional view of a ground contact unit according to a third embodiment of the invention;

FIG. 6 shows a schematic sectional view of a ground contact unit according to a fourth embodiment of the invention; and

FIG. 7 shows a top view of part of the ground contact unit according to FIG. 6, with the contact, the underlying contact bridge and the printed circuit board.

### DETAILED DESCRIPTION OF THE INVENTION

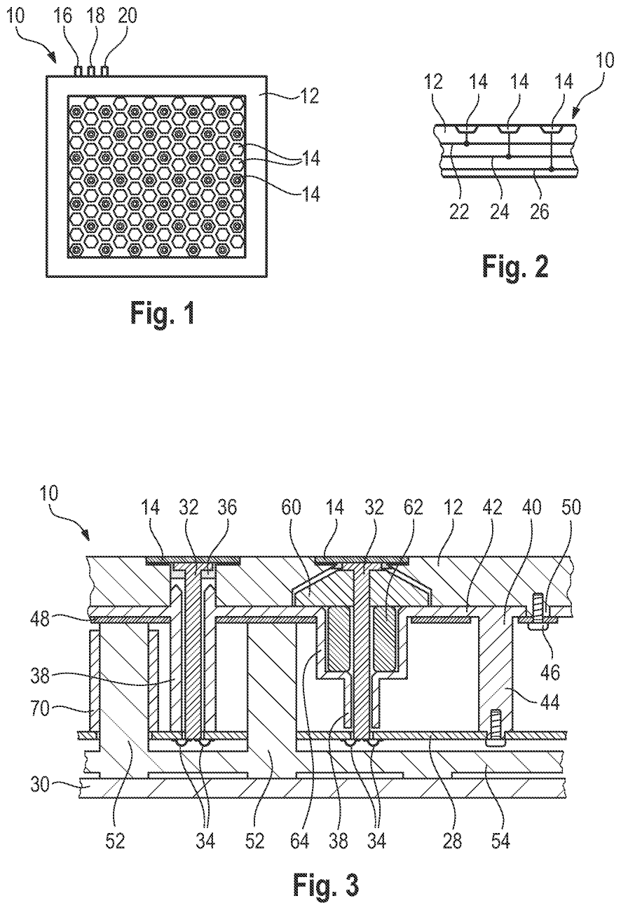

FIG. 1 shows a ground contact unit 10 for a vehicle battery charging system. This ground contact unit 10 is placed on the ground or laid at ground level on private or public property and has a plate-like shape with a relatively low height.

Briefly summarized, charging a battery works as follows: The hybrid or electric vehicle is driven over the ground contact unit. Subsequently, a vehicle contact unit having a plurality of contacts protruding on the underside is moved downward against the ground contact unit. It is determined in the ground contact unit which of its numerous contacts that are exposed on the top side have vehicle-side mating contacts that rest perfectly on them. The power supply to some of these contacts is activated so that the charging process can start.

Some details of the ground contact unit 10 will be described below.

The ground contact unit 10 has an upper outer wall 12, on which numerous contacts 14 arranged in a matrix-like manner are distributed. The contacts 14 are arranged in a pattern, in the embodiment shown in the form of a two-dimensional Bravais lattice, more precisely a hexagonal lattice.

In the example illustrated, the ground contact unit 10 comprises three ground connections 16, 18, 20, which are connected to a respective connection of a local electric power grid. Each of the ground connections 16, 18, 20 provides a different electric potential.

A potential level 22, 24, 26 is provided in the ground contact unit 10 for each potential (see FIG. 2). While only three potential levels are depicted, a different number of potential levels may also be provided. The potential levels are of course insulated from each other.

In the exemplary embodiment illustrated, the potential levels 22-26 are conductive layers of a printed circuit board 28, which is illustrated, for example, in FIG. 3. The printed circuit board 28 is located in the interior of the ground contact unit 10 in that the latter is made to be hollow.

This receiving space is bordered toward the ground by a so-called ground-side base 30, wherein the base 30 may either have side walls or the outer wall 12 may have side walls to the base 30, or separate side walls are provided which connect the outer wall 12 with the base 30 and provide for a liquid-tight receiving space in the interior of the ground contact unit 10.

When the vehicle contact unit is moved onto the ground contact unit 10, a plurality of contacts of the vehicle contact unit will come into contact with some contacts 14 of the ground contact unit 10. The correspondingly paired contacts are detected, and some of these contacts are then activated by respective circuits in the ground contact unit 10, while others remain blocked, so that the charging process can begin.

The internal structure of the ground contact unit 10, in particular the mechanical and electrical structure, will be discussed in more detail below.

The outer wall 12 has a number of recesses in the area of the contacts 14, the contacts 14 being glued onto the rear side of the outer wall 12 in the area of the bottom of the respective depression and being flush with the top side of the outer wall 12.

The contacts 14 are, for example, small stainless steel plates. Starting on the rear side of the contacts 14 is an electrical line, in this case consisting of several parts that lead up to corresponding contacts on the printed circuit board 28. One part of this electrical line is, for each contact 14, a pin 32 made of brass or steel, which has, for example, a plate-shaped end by which it is fastened to the rear side of the contact 14, for example by soldering, welding or bonding. In the area of the plate-shaped enlargements of the pins 32, the latter are additionally held and sealed in the outer wall 12 by means of a potting compound 36.

The pins 32 extend toward the base 30, preferably perpendicularly to the top side of the outer wall 12, and preferably extend past the printed circuit board 28 at a distance (either laterally past it or through recesses or openings in the printed circuit board 28).

Provided on the underside of the printed circuit board 28 is or are one or more flexible, freely extending contact bridges 34, which extend to the underside of the printed circuit board 28 and electrically connect the respective pin 32 there with the corresponding contact on the printed circuit board 28. Without this contact bridge or bridges 34, the pin 32 has no electrical contact with the printed circuit board 28.

As explained, the contact bridge or bridges 34 extend freely and are made to be freely deflectable like a spring toward the base 30. This means that when a vehicle stands on the ground contact unit 10 and the outer wall 12 spring-like deflects to a minimum extent, causing the corresponding pin 32 to travel downward, the contact bridge 34 will compensate for the changing distance between the lower end wall of the pin 32 and the underside of the printed circuit board 28.

The contact bridges 34 have an arcuate shape, in particular a U-shape. In the present case, the “U” is an upright U with the open side facing upwards. Alternatively, it could also be a reclining U.

The attachment of the contact bridges 34 to the pin 32 is performed by welding or soldering, but preferably by bonding, here in particular wire bonding.

The attachment of the contact bridge to the printed circuit board is carried out using the same types of attachment.

As an alternative to the embodiment shown in FIG. 3, the pin 32 may of course also end in the region of the top side or before the top side of the printed circuit board 28, so that the contact bridges 34 extend in an arc shape from the underside of the respective pin 32 to the top side of the printed circuit board 28, here also as a “U”.

A holder 40 is provided, having a holding plate 42 and integrally formed lateral guides 38 in the form of sleeves. The pin 32 on the left in FIG. 3 extends through a sleeve-shaped, lateral guide 38 of the holder 40. The holding plate 42 contacts the outer wall 12 on the underside. Extensions 44 that are integrally formed with the holding plate 42 extend from the latter to the printed circuit board 28, which is fastened to the extensions 44. In this way, the printed circuit board 28 is coupled to the outer wall 12 in a suspended manner via the holder 40, since the holder 40 is fastened to the outer wall 12 by means of fastening elements 46.

A shielding plate 48 may be fitted to the holder 40 below the holding plate 42. As can be seen in FIG. 3, a number of lateral guides 38 may also serve as a support for the printed circuit board 28.

The holder 40 is laterally oriented in relation to the outer wall 12 by means of projections 50 which project into recesses, more specifically complementary recesses (in this case in the plate 42).

In order to obtain a mechanical support for the outer wall 12 when a load is applied by a vehicle, a plurality of support parts 52 are provided which extend from the top side of the base 30 as far as to the outer wall 12, or, if the holder 40 and/or the shielding plate 48 are also provided below the outer wall as in the embodiment according to FIG. 3, as far as to the underside of the corresponding singular plate or of the plurality of plates. In this way, a mechanical bridge is achieved between the base 30 and the outer wall 12.

As can be seen in FIG. 3, the support parts 52 may also be coupled to each other in one piece or in several pieces by a connecting part 54, e.g. a plate. Optionally, the connecting part 54 may also be integrally connected to the base 30, in which case the support parts 52 project upward from the base 30 in one piece.

In the embodiment illustrated, the right-hand pin 32 is made of steel. It extends through an anchor cone 60, which is accommodated in a cone-like depression in the outer wall 12. Adjoining the anchor cone 60 on the underside thereof is a ferrite sleeve 62, which is accommodated in a bushing-shaped widening 64 of a lateral guide 38.

Here too, the contact bridges 34 are present on the underside of the pin 32. The ferrite sleeve 62 and the anchor cone conduct a magnetic field which is used for positioning and aligning the vehicle contact unit.

In the embodiment illustrated, one or more relays 70 are mounted on the top side of the printed circuit board 28.

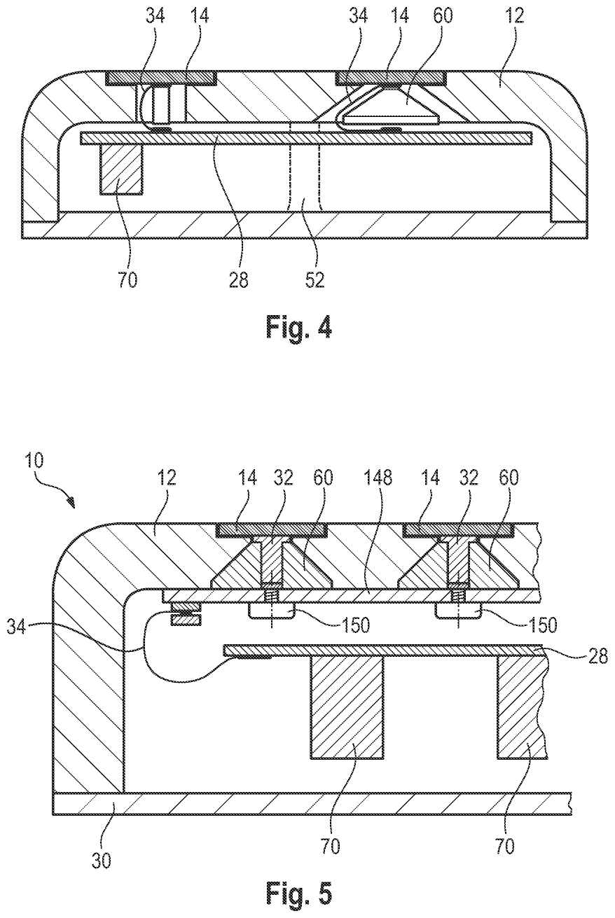

The embodiment according to FIG. 4 differs from that according to FIG. 3 regarding the following features, so that only the differences will be discussed and identical or functionally identical parts bear the reference numerals just introduced. In contrast to the embodiment according to FIG. 3, no pins are provided here; rather, the flexible, freely extending contact bridge 34 extends from the underside of the respective contact 14 to the printed circuit board 28. The attachment to the respective contact 14 and to the printed circuit board 28 is effected by means of the previously mentioned optional methods.

In the variant according to FIG. 4, the contact bridges 34 are fastened to the top side of the printed circuit board 28.

Since in this case the printed circuit board 28 is located relatively close to the outer wall 12 but spaced apart from it, relays 70 or other voluminous electronic components are attached to the underside of the printed circuit board 28.

Here too, the respective flexible, freely extending contact bridge 34 is of course configured as an arc in order to absorb movements as far as possible without a tensile load in the contact bridge 34. The contact bridges 34 are in the form of a reclining “U” here.

Even though only one contact bridge 34 per contact 14 is illustrated in the present case, two or more contact bridges 34 per contact 14 may also easily be provided here.

While no support parts are illustrated here according to FIG. 4, they may nevertheless be present.

Furthermore, a mounting holder may be provided which, as it were, receives all or a plurality of groups of contact bridges 34 and positions them relative to the printed circuit board 28 or to the contacts 14 so that soldering, welding or bonding can then be carried out automatically and preferably even with a plurality of simultaneous tools in order to attach all or numerous contact bridges jointly to the printed circuit board and/or the contacts 14 and/or the pins 32. The mounting holder may remain in the receiving space to position the contact bridges 34 relative to each other during operation.

As further indicated in FIG. 4, support parts 52 may also be integrally formed with the base 30.

In the embodiment shown in FIG. 5, an electrically conductive intermediate plate 148 is fastened to the rear side of the outer wall 12. This intermediate plate 148 electrically connects a plurality of protective earth contacts, also referred to as PE contacts.

The intermediate plate 148 is coupled to the pins 32, e.g. by means of fastening screws 150, which may at the same time be used for contacting. One contact bridge 34 is then sufficient to electrically connect all of the protective earth contacts to the printed circuit board 28.

The parts and sections already introduced bear the reference numerals already introduced, so that they need not be explained separately.

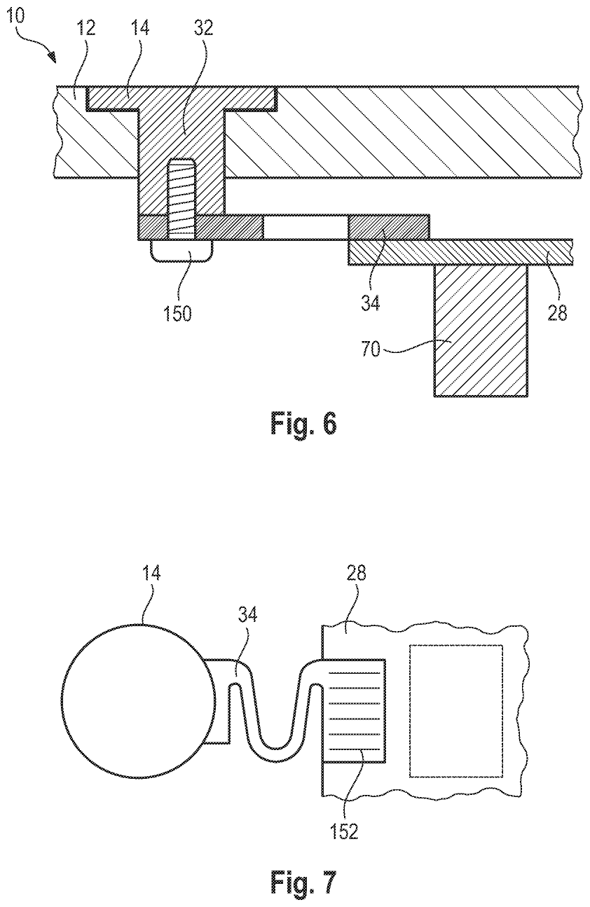

In the embodiment according to FIGS. 6 and 7, the contact bridge 34 is a “U” in a top view, rather than in a side view (see FIG. 7). It is therefore a horizontal “U”.

Here too—this is not to be understood in a limiting sense—the contact bridge, which may be a stamped part, is screwed to the underside of the pin 32; here, optionally, the pin 32 may transition into the contact 14 in one piece and protrudes from it at the rear.

Of course, other contact connections between the contact bridge 34 on the one hand and in the adjacent part, that is, the pin 32 or the printed circuit board 28, may also be provided in general, not limited to any embodiment, for example a pressing or crimping, which is symbolized by the lines 152 in FIG. 7, or a clamping between a two-part contact 14 or pin 32.

1. A ground contact unit for a vehicle battery charging system, comprising a ground-side base and an upper outer wall, wherein a receiving space in which at least one printed circuit board is positioned is formed between the base and the outer wall, and comprising a plurality of contacts provided on an outside of the outer wall for contacting vehicle-side mating contacts, the contacts being electrically conductively connected to the printed circuit board by means of electrical lines, wherein the lines are formed, at least in sections, by flexible, freely extending contact bridges which are configured to undergo a spring deflection toward the base.

2. The ground contact unit according to claim 1, wherein the contact bridges are mounted on one of a top side and a bottom side of the printed circuit board.

3. The ground contact unit according to claim 1, wherein, in a side view or a top view of the ground contact unit, the contact bridges each describe at least one arc, a shape of which changes upon a movement of the associated contact perpendicular to the upper outer wall, with the contact bridge being elastically deformed.

4. The ground contact unit according to claim 1, wherein the contact bridges are fastened by their ends to the respectively adjacent part by wire bonding, welding, soldering, pressing, crimping, clamping or screwing.

5. The ground contact unit according to claim 1, further comprising pins on an inside of the contacts on the outer wall, the pins being formed as separate parts relative to the contacts or being integrally formed with the contacts on a rear side thereof and projecting therefrom, the pins extending toward the associated printed circuit board and constituting a section of the respective electrical line, and wherein at least one respective contact bridge extends between the pins and the printed circuit board, the contact bridge being resiliently spring-like deflectable in a longitudinal direction of the pins and electrically connecting the pin to the printed circuit board.

6. The ground contact unit according to claim 5, wherein the pin extends past the associated printed circuit board.

7. The ground contact unit according to claim 5, wherein a plurality of contact bridges are jointly bonded or welded or soldered to at least one printed circuit board and/or associated pins.

8. The ground contact unit according to claim 5, wherein the contact bridges are integrated in the associated printed circuit board and are fastened by their respective free end to the associated pin.

9. The ground contact unit according to claim 5, wherein a plurality of contact bridges is provided per pin.

10. The ground contact unit according to claim 5, wherein at least some contact bridges are received in a mounting holder which is accommodated within the receiving space and which positions the contact bridges relative to the at least one printed circuit board and the pins.

11. The ground contact unit according to claim 5, wherein the pins are welded to the contacts of the outer wall by contact welding.

12. The ground contact unit according to claim 5, wherein a lateral guide is provided for each pin.

13. The ground contact unit according to claim 12, wherein the lateral guide is formed by a sleeve which is attached to or integrally formed with a holding plate, and wherein the pin extends into the sleeve.

14. The ground contact unit according to claim 13, wherein the holding plate is fastened, on one hand, to the outer wall and, on the other hand, to the at least one printed circuit board in order to hold the printed circuit board.

15. The ground contact unit according to claim 13, wherein the holding plate and the outer wall are positioned laterally in relation to each other by projections that engage in recesses.

16. The ground contact unit according to claim 1, wherein support parts extend between the outer wall and the base, which support the outer wall on the base in a vertical direction.

17. The ground contact unit according to claim 16, wherein the support parts are integrally formed with the base.

18. The ground contact unit according to claim 1, wherein an electrically conductive intermediate plate is attached to the outer wall on a rear side thereof, a plurality of contacts, which are protective earth contacts, being electrically coupled to the intermediate plate, wherein the intermediate plate is connected to the printed circuit board by means of a contact bridge.
